(19) United States
(12) Patent Application Publication
(10) Pub. No.: US 2006/0083326 A1
(43) Pub. Date: Apr. 20, 2006

(54) System for wireless resource assignment in multiband OFDM

(75) Inventors: Jae-ho Roh, Seoul (KR); Jae-hyun Koo, Seoul (KR); Sung-hyun Chung, Seongnam-si (KR); Jae-min Ahn, Yongin-si (KR); Min-Joong Rim, Seoul (KR)

Correspondence Address: SUGHRUE MION, PLLC, 2100 PENNSYLVANIA AVENUE, N.W., SUITE 800, WASHINGTON, DC, 20037, US

(73) Assignees: SAMSUNG ELECTRONICS CO., LTD.; ALOGICS CO., LTD

(21) Appl. No.: 11/250,381

(22) Filed: Oct. 17, 2005

Related U.S. Application Data
(60) Provisional application No. 60/618,592, filed on Oct. 15, 2004.

(30) Foreign Application Priority Data
Apr. 28, 2005 (KR) 2005-35386

(51) Int. Cl. H04K 1/10

(52) U.S. Cl. 375/260

(57) ABSTRACT

A multi-band orthogonal frequency division multiplexing (OFDM) system transmits the same symbol at least two times, and a receiving end can receive transmission data from a transmitting end accurately even when an error occurs from a wireless resource used by the multi-band OFDM system. To this end, the multi-band OFDM system has a transmitting end which selects one among at least three symbols being repetitively transmitted at least two times, and transmits the selected symbol by using different wireless resources so that the selected symbol is not consecutively transmitted, and a receiving end which receives the symbols from the transmitting end.

### CROSS-REFERENCE TO RELATED APPLICATION

This application claims priority from U.S. Provisional Application No. 60/618,592 filed on Oct. 15, 2004 in the United States Patent and Trademark Office, and Korean Patent Application No. 2005-35386 filed on Feb. 17, 2005 in the Korean Intellectual Property Office, the entire contents of which are incorporated herein by reference.

### BACKGROUND OF THE INVENTION

1. Field of the Invention

The present invention relates to a multi-band orthogonal frequency division multiplexing (OFDM), and more particularly, to an efficient symbol transmitting for an OFDM system which transmits symbols using a plurality of sub-bands.

2. Description of the Prior Art

An OFDM system transmits serially-incoming symbols by converting the symbols into parallel pattern of a predetermined size, and multiplexing the parallel symbols into subcarrier frequencies at orthogonal relation with each other.

A multi-band OFDM scheme transmits OFDM symbols, with hopping a plurality of frequency bands in the unit of symbols. One representative example can be found in a wireless communication system such as an Ultra Wideband (UWB) system. Accordingly, a multi-band OFDM scheme is used in association with a frequency hopping technology. A multi-band OFDM system, applied in the UWB, will be briefly described below. A multi-band OFDM system has a plurality of sub-bands of predetermined frequency bands. By transmitting the data (symbols) using the sub-bands, the multi-band OFDM system can transmit or receive a huge volume of data in unit time. Data security is guaranteed as the UWB system selects one of the sub-bands, and uses the selected sub-band according to predetermined rules.

FIG. 1 illustrates the sub-bands used in a current multi-band OFDM system. As shown, the current multi-band OFDM system uses frequency bands which have center frequency ranging from 3432 MHz to 10296 MHz. The multi-band OFDM frequency band consists of mainly five groups. Each of the first through fourth groups consists of three sub-bands, while the fifth group consists of two sub-bands.

The center frequency of three sub-bands of the first group is, respectively, 3432 MHz, 3960 MHz, and 4488 MHz. The center frequency of three sub-bands of the second group is, respectively, 5016 MHz, 5544 MHz, and 6072 MHz. The center frequency of three sub-bands of the third group is, respectively, 6600 MHz, 7128 MHz, and 7656 MHz. The center frequency of three sub-bands of the fourth group is, respectively, 8184 MHz, 8712 MHz, and 9240 MHz. The center frequency of the two sub-bands of the fifth groups is, respective, 9768 MHz and 10296 MHz.

The following Table 1 lists frequency bands being used in a multi-band OFDM system.

TABLE 1

| TFC | | | | | | |
|---|---|---|---|---|---|---|
| No. | Symbol 1 | | Symbol 2 | | Symbol 3 | |
| 1 | 1st sub- | 2nd sub- | 3rd sub- | 1st sub- | 2nd sub- | 3rd |
| | band | band | band | band | band | sub- |
| | | | | | | band |
| 2 | 1st sub- | 3rd sub- | 2nd sub- | 1st sub- | 3rd sub- | 2nd |
| | band | band | band | band | band | sub- |
| | | | | | | band |
| 3 | 1st sub- | 1st sub- | 2nd sub- | 2nd sub- | 3rd sub- | 2nd |
| | band | band | band | band | band | sub- |
| | | | | | | band |
| 4 | 1st sub- | 1st sub- | 3rd sub- | 3rd sub- | 2nd sub- | 2nd |
| | band | band | band | band | band | sub- |
| | | | | | | band |

As shown in Table 1, a multi-band OFDM system transmits symbols, by using three sub-bands.

Hereinbelow, a multi-band OFDM system transmitting symbols using three sub-bands, will be described with reference to FIGS. 2A through 2D and Table 1.

FIGS. 2A through 2D show Time Frequency Code (TFC) Nos. 1 through 4. A multi-band OFDM system twice transmits one symbol. With reference to Table 1 and FIG. 2A, TFC No. 1 transmits symbol 1 using first an second sub-bands, transmits symbol 2 using third and first sub-bands, and transmits symbol 3 using third and second sub-bands.

Referring to FIG. 2B, TFC No. 2 transmits symbol 1 using the first and third sub-bands, transmits symbol 2 using second and first sub-bands, and transmits symbol 3 using third and second sub-bands. Referring to FIG. 2C, TFC No. 3 twice transmits the symbol 1 using the first sub-band only, twice transmits symbol 2 using the second sub-band only, and twice transmits symbol 3 using the third sub-band only. Referring to FIG. 2D, TFC No. 4 twice transmits symbol 1 using the first sub-band only, twice transmits symbol 2 using the third sub-band only, and twice transmits symbol 3 using the second sub-band only.

With reference to Table 1 and FIGS. 2A through 2D, TFC No. 3 and TFC No. 4 transmit one symbol not using different sub-bands, but using the same sub-band. Accordingly, if error occurs in the first sub-band, TFC No. 3 and TFC No. 4 cannot transmit the symbol 1. When an error occurs in the second sub-band, TFC No. 3 can not transmit symbol 2, and TFC No. 4 can not transmit symbol 3. When an error occurs in the third sub-band, TFC No. 3 can not transmit symbol 3, and TFC No. 4 can not transmit symbol 2.

Generally, when a symbol is received, the receiving end of a multi-band OFDM system first searches the first sub-band. In other words, the receiving end of the multi-band OFDM system acquires necessary information from the symbols of the first sub-band, and acquires necessary information from the symbols of the second and third sub-bands, using the acquired information from the symbols of the first sub-band.

Additionally, with reference to Table 1 and FIGS. 2A through 2D, the first symbol and the second symbol, which are transmitted from TFC No. 1 and TFC No. 2 over the first sub-band, are received at a predetermined time interval. However, the first and the second symbols of symbol 1, which are transmitted from TFC No. 3 and TFC No. 4 over the first sub-band, are received consecutively. Accordingly, with respect to TFC No. 3 and TFC No. 4, in order to process the first symbol transmitted from the first sub-band, the receiving end gives up the second symbol. In other words, in TFC No. 3 and TFC No. 4, the receiving end does not have enough margin (interval between the reception of the first symbol and the second symbol) to process the second symbol being transmitted over the first sub-band.

### SUMMARY OF THE INVENTION

The present invention provides a method for a multi-band OFDM system which at least twice transmits the same symbol, which enables a receiving end to receive symbols from a transmitting end without having an error.

According to an aspect of the present invention, there is provided a multi-band OFDM system, which includes a transmitting end which selects one among at least three symbols being repetitively transmitted at least two times, and transmits the selected symbol by using different wireless resources so that the selected symbol is not consecutively transmitted; and a receiving end which receives the symbols from the transmitting end.

The transmitting end transmits an n-th transmission symbol and an (n+1)th transmission symbol using the same wireless resource, and n is an even number which is equal or greater than 0. The wireless resource is a frequency band.

The transmitting end may select a lowest frequency among at least three frequency bands, and transmit the selected symbol a first time using a wireless resource having the selected frequency band. The wireless resource may consist of a first sub-band having a first frequency band, a second sub-band having a second frequency band, and a third sub-band having a third frequency band.

### BRIEF DESCRIPTION OF THE DRAWINGS

The above and/or other aspects of the present invention will become more apparent by describing in detail exemplary embodiments thereof with reference to the attached drawings, in which:

FIG. 1 illustrates a frequency band being used in a multi-band OFDM system;

FIGS. 2A through 2D illustrate examples of a multi-band OFDM system transmitting symbols by using three sub-bands;

FIG. 3 illustrates the structure of a preamble with respect to TFC No. 1 and TFC No. 2 of a multi-band OFDM system;

FIG. 4 illustrates a method for a transmitting end to transmit symbols by using TFC No. 3 according to an exemplary embodiment of the present invention;

FIG. 5 illustrates a method for a transmitting end to transmit six symbols by using TFC No. 4 according to an exemplary embodiment of the present invention; and

FIG. 6 illustrates symbols being input to, and output from an interleaver according to an exemplary embodiment of the present invention.

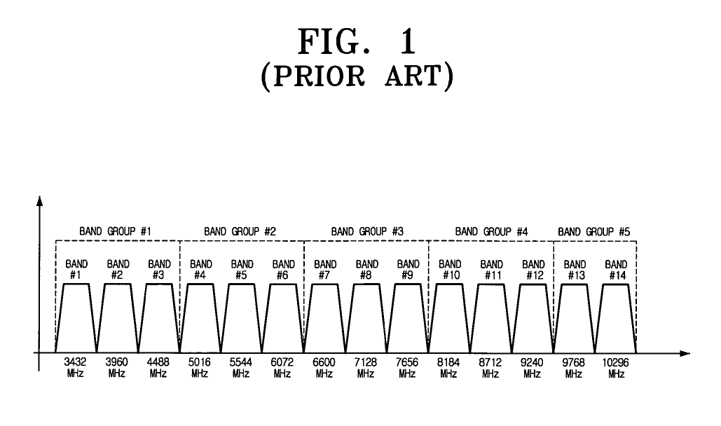

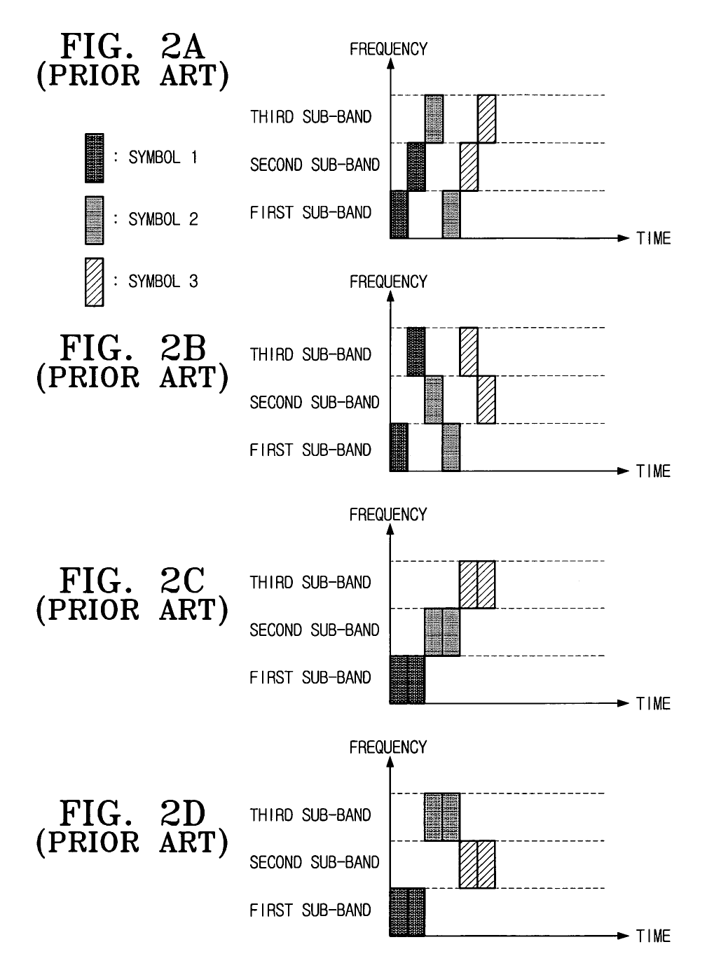

### DETAILED DESCRIPTION OF EXEMPLARY EMBODIMENTS

Hereinafter, the present invention will be described in detail with reference to the drawings. The present invention proposes a method for transmitting the same symbol with using different sub-bands.

A symbol in a communication system can be divided into a preamble part and a payload part. The preamble contains brief information about symbol transmission, and the payload contains effective data which are transmitted from the transmitting end to a receiving end.

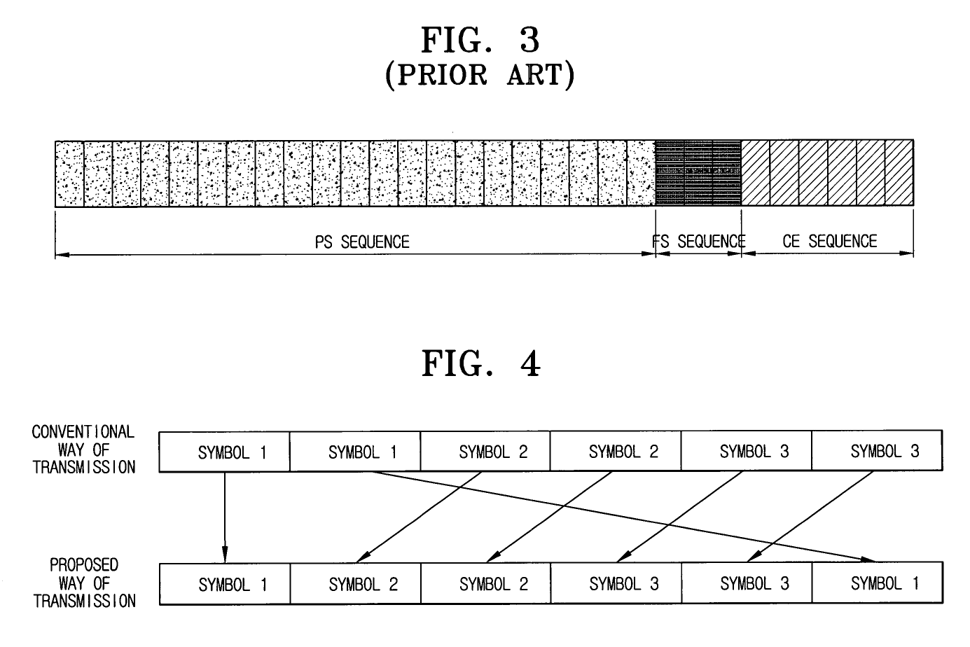

FIG. 3 illustrates the preamble structure with respect to TFC No. 1 and TFC No. 2 being used in a multi-band OFDM system. With reference to FIG. 3, a preamble includes a packet synchronization (PS) sequence of 21 symbols, a frequency synchronization (FS) sequence of 3 symbols, and a channel estimation (CE) sequence of 6 symbols. Each symbol is 312.5 ns in length.

The PS sequence is used to detect symbols, estimate frequency (sub-band) for use, and acquire synchronization. Additionally, the PS sequence is used to calculate gains with respect to the received symbols. The FS sequence is used to detect a boundary of the frame, and distinguish the PS and CE sequences from the detected information. The CE sequence is used to perform channel estimation.

Table 2 below lists a method for transmitting payload according to the transmission rate of a multi-band OFDM system.

TABLE 1

| Transmission rate | | | |
|---|---|---|---|
| (Mbps) | Modulation | Encoding rate | TSF |
| 53.3 | QPSK | ⅓ | 2 |
| 55 | QPSK | 11/32 | 2 |
| 80 | QPSK | ½ | 2 |
| 106.67 | QPSK | ⅓ | 2 |
| 110 | QPSK | 11/32 | 2 |
| 160 | QPSK | ½ | 2 |
| 200 | QPSK | ⅝ | 2 |
| 320 | DCM | ½ | 1 |
| 400 | DCM | ⅝ | 1 |
| 480 | DCM | ¾ | 1 |

With the transmission rate ranging from 53.3 Mbps to 200 Mbps, a multi-band OFDM system uses a quadrature phase shift keying (QPSK), while the system uses a dual carrier modulation (DCM) with respect to the transmission rate ranging from 320 Mbps to 480 Mbps.

Additionally, when the transmission rate ranges from 53.3 Mbps to 200 Mbps, a multi-band OFDM system has a Time Spreading Factor (TSF) of 2. In other words, when the transmission rate ranges from 53.3 Mbps to 200 Mbps, a transmitting end of a multi-band OFDM system twice transmits one symbol at predetermined time interval.

FIG. 4 illustrates a method for transmitting a symbol by using TFC No. 3 according to an exemplary embodiment of the present invention. As shown, conventionally, each of the three symbols is consecutively transmitted two times by using TFC No. 3. In other words, the transmitting end consecutively transmits symbol 1 two times using a first sub-band from the first and second points, and consecutively transmits symbol 2 two times using a second sub-band from the third and fourth points, and consecutively transmits symbol 3 two times using a third sub-band from the fifth and sixth points, respectively.

Compared to the conventional example, the present invention proposes to transmit repetitive transmission symbols over different frequency bands, without shifting frequency hopping pattern. In one example, symbol 1 may be transmitted from the first and sixth points, instead of being consecutively transmitted from the first and second points. More specifically, a transmitting end may transmit symbol 1 from the first and sixth points, transmit symbol 2 from the second and third points, and transmit symbol 3 from the fourth and fifth points.

By doing as the above, symbol 1 is transmitted over the first and third sub-bands, symbol 2 is transmitted over the first and second sub-bands, and symbol 3 is transmitted over the second and third sub bands. As the transmitting end sends out symbols 1 to 3 in the way described above, a multi-band OFDM system can have not only time diversity, but also frequency diversity.

An alternative method to transmit three symbols using TFC No. 3 will now be described below.

The transmitting end transmits symbol 1 from first and sixth points, transmits symbol 2 from fourth and fifth points, and transmits symbol 3 from second and third points. Accordingly, symbol 1 is transmitted over the first and third sub-bands, symbol 2 is transmitted over the second and third sub-bands, and symbol 3 is transmitted over the first and second sub-bands.

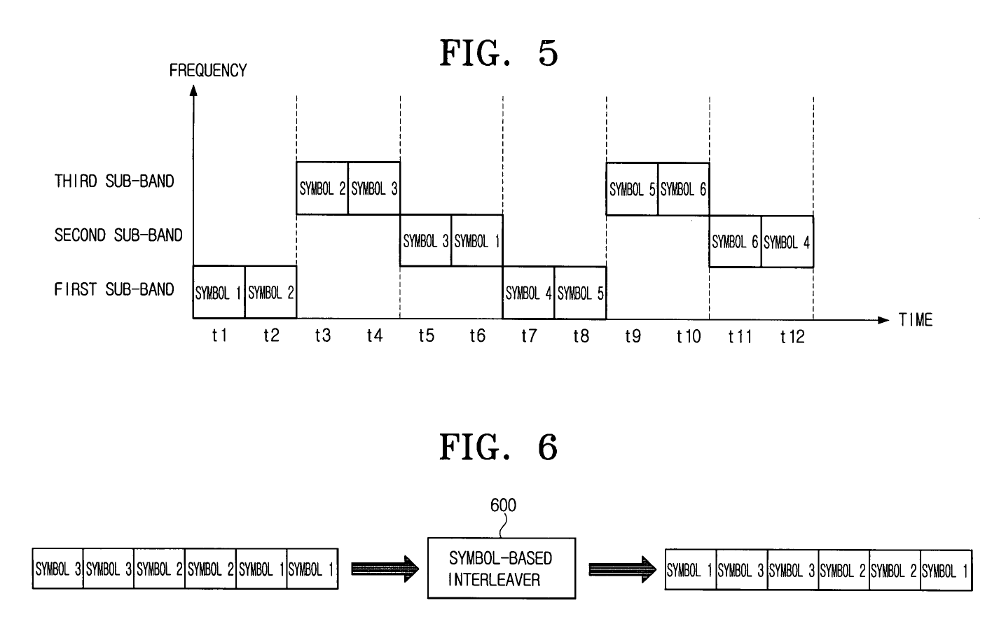

FIG. 5 illustrates a method for a transmitting end to transmit six symbols using TFC No. 4 according to an exemplary embodiment of the present invention. As described above, the transmitting end collectively processes the first group of symbols 1 to 3, and collectively processes the second group of symbols 4 to 6.

Symbol 1 of the first group is transmitted from the first and sixth points, symbol 2 is transmitted from the second and third points, and symbol 3 is transmitted from the fourth and fifth points. Symbol 4 of the second group is transmitted from the seventh and twelfth points, symbol 5 is transmitted from the eighth and ninth points, and symbol 6 is transmitted from the tenth and eleventh points.

Accordingly, symbol 1 is transmitted over the first and second sub-bands, symbol 2 is transmitted over the first and third sub-bands, and symbol 3 is transmitted over the third and second sub-bands. Symbol 4 is transmitted over the first and second sub-bands, symbol 5 is transmitted over the first and third sub-bands, and symbol 6 is transmitted over the third and second sub-bands.

By transmitting symbol 1 using different sub-bands as shown in FIG. 5, a multi-band OFDM system can have not only time diversity, but also frequency diversity. The same effect is also obtained with respect to symbols 2 to 6.

An alternative method of transmitting three symbols using TFC No. 4, will now be described below.

A transmitting end transmits symbol 1 from first and sixth points, transmits symbol 2 from fourth and fifth points, and transmits symbol 3 from second and third points. Accordingly, symbol 1 is transmitted over the first and second sub-bands, symbol 2 is transmitted over the third and second sub-bands, and symbol 3 is transmitted over the first and third sub-bands.

The transmitting end includes a symbol-based interleaver which keeps symbols for transmission in a predetermined order in time domain so that the symbols can be transmitted by using TFC No. 3 or TFC No. 4. More specifically, the transmitting end is provided with the symbol-based interleaver to transmit the consecutively received symbols 1 to 3 in the way as explained with reference to FIG. 4.

FIG. 6 illustrates symbols being inputted to, and outputted from the symbol-based interleaver according to an exemplary embodiment of the present invention.

Referring to FIG. 6, a symbol-based interleaver 600 receives six symbols of two symbol 1s, two symbol 2s, and two symbol 3s. The symbol-based interleaver 600 outputs the received six symbols in the sequential order of symbol 1, symbol 2, symbol 2, symbol 3, symbol 3 and symbol 1. As the symbol-based interleaver 600 outputs symbols in the order different from the input order, there is no need to provide a separate structure for the transmitting end.

The receiving end includes a symbol-based deinterleaver to reverse interleave at the symbol-based interleaver 600 of the transmitting end.

As described above, by transmitting symbol containing the same information with using at least different wireless resources, the receiving end can safely receive the data through an intact wireless resource, when an error occurs from one of the wireless resources. Additionally, because the symbols are not consecutively transmitted using the same wireless resource, time for processing received symbols is guaranteed.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents.

What is claimed is:

1. A multi-band orthogonal frequency division multiplexing (OFDM) system comprising:
a transmitting end which selects one among at least three symbols being repetitively transmitted at least two times, and transmits at least two times the selected symbol using different wireless resources so that the selected symbol is not consecutively transmitted; and
a receiving end which receives the symbols from the transmitting end.

2. The multi-band OFDM system of claim 1, wherein the transmitting end transmits an n-th transmission symbol and an (n+1)th transmission symbol using a same wireless resource, and n is an even number which is equal to or greater than 0.

3. The multi-band OFDM system of claim 2, wherein the same wireless resource comprises a sub-band having a center frequency.

4. The multi-band OFDM system of claim 3, wherein the transmitting end selects a lowest center frequency among at least three center frequencies, and transmits the selected symbol a first time using a sub-band having the selected center frequency.

5. The multi-band OFDM system of claim 4, wherein the wireless resource comprises a first sub-band having a first center frequency, a second sub-band having a second center frequency, and a third sub-band having a third center frequency.

6. The multi-band OFDM system of claim 5, wherein the transmitting end transmits a first symbol, a second symbol and a third symbol two times from first to sixth transmission points, and the first symbol is transmitted from the first and the sixth transmission points.

7. The multi-band OFDM system of claim 5, wherein the receiving end searches the first sub-band if the reception of the symbol is detected.

8. The multi-band OFDM system of claim 5, wherein the center frequency of the first sub-band is lower than the center frequencies of the second and the third sub-bands.

9. The multi-band OFDM system of claim 1, wherein each of the symbols comprises a preamble, and a payload having a transmission rate not more than 200 Mbps.

10. The multi-band OFDM system of claim 1, wherein the transmitting end selects one among four transmission patterns, and transmits the symbols by using the selected transmission pattern.

11. The multi-band OFDM system of claim 10, wherein the transmitting end selects a transmission pattern which does not overlap with transmission patterns of neighboring devices.

12. The multi-band OFDM system of claim 1, wherein the transmitting end comprises a symbol-based interleaver which interleaves the received symbols based on a symbol unit.

13. A method for wireless resource assignment in a multi-band OFDM system, the method comprising:
selecting one among at least three symbols being repetitively transmitted at least two times; and
transmitting at least two times the selected symbol by using different wireless resources so that the selected symbol is not consecutively transmitted.

14. The method of claim 13, wherein the transmitting comprises transmitting an n-th transmission symbol and an (n+1)th transmission symbol using a same wireless resource, and n is an even number which is equal to or greater than 0.

15. The method of claim 14, wherein the same wireless resource comprises a sub-band having a center frequency.

16. The method of claim 15, wherein the transmitting comprises:
selecting a lowest center frequency among at least three center frequencies; and
transmitting the selected symbol a first time using a sub-band having the selected center frequency.

17. The method of claim 16, wherein the wireless resource comprises a first sub-band having a first center frequency, a second sub-band having a second center frequency, and a third sub-band having a third center frequency.

18. The method of claim 17, wherein the transmitting comprises transmitting a first symbol, a second symbol and a third symbol two times from first to sixth transmission points, and the first symbol is transmitted from the first and the sixth transmission points.

19. The method of claim 17, wherein the center frequency of the first sub-band is lower than the center frequencies of the second and the third sub-bands.

20. The method of claim 1, wherein the selecting comprises selecting one among four transmission patterns, and the transmitting comprises transmitting the symbols by using the selected transmission pattern.

21. The method of claim 21, wherein the selecting comprises selecting a transmission pattern which does not overlap with transmission patterns of neighboring devices.

22. The method of claim 1, wherein the transmitting comprises interleaving the symbols received from the transmitting end based on a symbol unit.
